(19) United States
(12) Patent Application Publication
(10) Pub. No.: US 2025/0051557 A1
(43) Pub. Date: Feb. 13, 2025

(54) Composition comprising a thermoplastic elastomer and a crosslinked rubber powder

(71) Applicant: ARKEMA FRANCE, COLOMBES (FR)

(72) Inventor: Thomas PRENVEILLE, Serquigny (FR)

(73) Assignee: ARKEMA FRANCE, COLOMBES (FR)

(21) Appl. No.: 18/719,535

(22) PCT Filed: Dec. 22, 2022
(86) PCT No.: PCT/FR2022/052478

§ 371 Date: Jun. 13, 2024

(30) Foreign Application Priority Data
Dec. 23, 2021 (FR) FR2114457

(51) Int. Cl. C08L 19/00; B29C 45/00; B29K 407/00; C08L 75/04; C08L 77/10

(52) U.S. Cl. CPC C08L 19/003; B29C 45/0001; B29C 45/0013; C08L 75/04; C08L 77/10; B29K 2407/00; B29K 2995/007; B29K 2995/0077; C08L 2205/02; C08L 2205/14; C08L 2207/24

(57) ABSTRACT

The invention relates to a composition comprising, relative to the total weight of the composition:
from 20% to 90%, preferably from 40% to 70%, by weight of at least one thermoplastic elastomer (TPE), preferably an elastomeric thermoplastic copolymer, and
from 10% to 80%, preferably from 30% to 60%, by weight of at least one crosslinked rubber powder, the crosslinked rubber powder having a specific surface area of between 0.08 m²/g and 100 m²/g, preferably between 0.1 and 80 m²/g, more preferentially between 0.1 and 50 m²/g,
from 0 to 5%, preferably from 0.1% to 4% and notably from 1% to 2% of additives;
from 0 to 40%, preferably from 5% to 20% and notably from 10% to 15% of compatibilizers.

### FIELD OF THE INVENTION

The present invention relates to compositions based on thermoplastic elastomer and crosslinked rubber powder, notably resulting from the shredding of used tires, and also to a process for preparing same. The invention also relates to articles consisting of or comprising an element consisting of or comprising such compositions, such as shoe soles, to the process for preparing same, and to the process for recycling same. The invention also relates to granules, filaments or powders obtained via this recycling process, and also to articles prepared therefrom.

### TECHNICAL BACKGROUND

Thermoplastic elastomers (TPEs) are used notably in the field of sports equipment, such as for soles or sole components, gloves, rackets or golf balls, or personal protection items for practising sports (jackets, interior parts of helmets, shells, etc.). Such applications require a material which has a set of particular physical properties, notably good rebound capacity, a low residual tensile strain and a capacity for enduring repeated impacts and for returning to the initial shape.

Moreover, there is a strong need to use recycled materials, for example used tires.

WO 17/021164 describes a composition comprising rubber powder, thermoplastic polyurethanes obtained from a polyisocyanate and a polyol, and also a polysiloxane. This composition may notably be used for shock absorption in a shoe sole.

There is nevertheless a real need to provide a composition with good springback and low density, while at the same time offering good abrasion resistance, good antislip properties and good tensile strength.

### SUMMARY OF THE INVENTION

The present invention relates firstly to a composition comprising, relative to the total weight of the composition:
from 20% to 90%, preferably from 40% to 70%, by weight of at least one thermoplastic elastomer (TPE), preferably an elastomeric thermoplastic copolymer, and
from 10% to 80%, preferably from 30% to 60%, by weight of at least one crosslinked rubber powder, the crosslinked rubber powder having a specific surface area of between 0.08 m²/g and 100 m²/g, preferably between 0.1 and 80 m²/g, more preferentially between 0.1 and 50 m²/g,
from 0 to 5%, preferably from 0.1% to 4% and notably from 1% to 2% of additives;
from 0 to 40%, preferably from 5% to 20% and notably from 10% to 15% of compatibilizers.

In certain embodiments of the composition according to the invention:
the crosslinked rubber powder has a specific surface area of between 0.08 m²/g and 0.5 m²/g, preferably between 0.1 and 0.3 m²/g, more preferentially between 0.1 and 0.2 m²/g,
the crosslinked rubber powder has a median diameter D50 of between 2 and 500 μm, preferably between 50 and 300 μm, and more preferentially between 60 and 200 μm;
the diameter D90 of the crosslinked rubber powder is between 10 and 800 μm, preferably between 80 and 500 μm, and more preferentially between 100 and 300 μm;
the rubber of the crosslinked rubber powder is a natural or synthetic rubber or a mixture thereof;
the rubber of the crosslinked rubber powder contains from 10% to 80% by weight, preferably from 15% to 70% by weight, of natural rubber;
the natural rubber is cis-1,4-polyisoprene or trans-1,4-polyisoprene;
the crosslinked rubber powder comprises styrene-butadiene rubber, preferably in a content greater than 5% by weight, more preferentially greater than 10% by weight;
the crosslinked rubber powder is obtained from used tires;
the crosslinked rubber powder is obtained by water-jet chopping of a tire;
the crosslinked rubber powder contains from 1% to 70%, preferably from 5% to 50%, more preferentially from 10% to 40% of carbon black and/or silica;
the at least one TPE is chosen from polyamide elastomers, thermoplastic polyurethanes, polyester elastomers, styrene-butadiene block copolymers and styrene-ethylene-butadiene block copolymers, and mixtures thereof, preferably from polyamide elastomers, thermoplastic polyurethanes and polyester elastomers, and mixtures thereof;
the TPE comprises flexible polyether and/or polyester blocks, preferably polyether, more preferentially PTMG, and/or rigid blocks chosen from polyamides, polyurethanes and polyesters;
the rigid block is a polyamide comprising at least one Z- or XY-type unit:
   Z being a lactam or amino acid containing from 6 to 18 carbon atoms,
   X being a diamine containing from 4 to 48 carbon atoms,
   Y being a diacid containing from 6 to 48 carbon atoms;
the rigid block is a polyurethane comprising at least one XY unit:
   X being a diisocyanate,
   Y being a diol;
the rigid block is a polyester comprising at least one XY unit:
   X being a dicarboxylic acid,
   Y being a diol;
the ratio of flexible blocks to rigid blocks is chosen so that the tensile modulus according to ISO 527 is between 5 and 800 MPa, preferably between 10 and 300 MPa, and more preferentially between 20 and 150 MPa;
the TPE has a Shore hardness of between 10 D and 70 D, preferably between 25 D and 50 D.

The invention also relates to a process for preparing a composition according to the invention, comprising the following steps:
mixing, preferably in an extruder, of
   from 20% to 90% by weight, preferably from 40% to 70% by weight, of at least one thermoplastic elastomer, preferably a copolymer, in the molten state and
   from 10% to 80%, preferably from 30% to 60%, by weight of at least one crosslinked rubber powder with a specific surface area of between 0.08 m²/g and 100 m²/g, preferably between 0.1 and 80 m²/g, more preferentially between 0.1 and 50 m²/g,
   from 0 to 5%, preferably from 0.1% to 4% and notably from 1% to 2% of additives,
   from 0 to 40%, preferably from 5% to 20% and notably from 10% to 15% of,
optionally, forming the mixture into the form of granules, filaments or powder, and/or
recovering the composition obtained.

The invention also relates to an article consisting of or comprising at least one element consisting of or comprising a composition according to the invention.

Said article is preferably chosen from footwear components such as soles, sports equipment parts such as ski pole parts, racket and golf club handles, goalkeeper gloves, treadmills, aquatic equipment such as diving booties, mask and snorkel parts, spectacle frame parts (sleeves, temples, nose pads), ski mask frames, vibration-isolating parts for electronics and machinery, external battery shells, automotive parts (seals, end caps), toys, watch straps, machine buttons, seals or conveyor belt components.

The invention also relates to a process for manufacturing an article according to the invention, comprising the steps of:
providing a composition according to the invention;
injection molding of said composition.

The invention also relates to a process for recycling an article according to the invention, comprising the following successive steps:
a) a) recovering, after optional separation, at least part of said article made of thermoplastic material comprising a composition according to the invention,
b) b) grinding the thermoplastic material to obtain particles,
c) c) melting the particles to obtain a molten mixture, and
d) d) optionally, adding other components to the molten mixture,
e) e) optionally, forming granules, filaments or powders from the molten mixture obtained on conclusion of step c) or d), and
f) f) optionally, forming the granules, filaments or powders into shape.

The invention also relates to a granule, filament or powder that may be obtained according to the recycling process according to the invention.

The invention also relates to an article consisting of or comprising at least one element prepared from said granules, filaments or powders.

The present invention makes it possible to meet the need expressed above. More particularly, it provides a composition which has good abrasion resistance, good antislip properties as estimated by means of the coefficient of friction, and good tensile properties. This composition notably has good elastic recovery, high elongation at break, good adhesion to wet surfaces, and is recyclable due to its meltable nature.

This is achieved by means of using particular amounts of at least one thermoplastic elastomer (TPE), preferably an elastomeric thermoplastic copolymer, and at least one crosslinked rubber powder, of well-defined specific surface area.

### DESCRIPTION OF THE INVENTION

The invention is now described in greater detail and in a nonlimiting manner in the description that follows.

Thus, according to a first aspect, the invention relates to a composition comprising, relative to the total weight of the composition:
from 20% to 90%, preferably from 40% to 70%, by weight of at least one thermoplastic elastomer (TPE), preferably an elastomeric thermoplastic copolymer, and
from 10% to 80%, preferably from 30% to 60%, by weight of at least one crosslinked rubber powder, the crosslinked rubber powder having a specific surface area of between 0.08 m² and 100 m²/g,
from 0 to 5%, preferably from 0.1% to 4% and notably from 1% to 2% of additives;
from 0 to 40%, preferably from 5% to 20% and notably from 10% to 15% of compatibilizers.

### Crosslinked Rubber Powder

The crosslinked rubber powder used in the compositions of the invention is characterized by a particular specific surface area, of between 0.08 m² and 100 m²/g. This specific surface area is measured by the BET method as described in Shen et al. Constr. Build. Mater. 2009, 23 (1), 304-310.

According to a preferred embodiment, the specific surface area of the rubber powder is between 0.08 and 100 m²/g, in particular between 0.1 and 80 m²/g, most particularly between 0.1 and 50 m²/g, notably between 0.1 and 0.3 m²/g, more preferentially between 0.1 and 0.2 m²/g. It is advantageously between 0.1 and 0.18 m²/g, notably between 0.12 and 0.16 m²/g.

Preferably, the crosslinked rubber powder has a particular particle size, notably a specific D50, D90 and/or D10 diameter characterizing the size distribution of the crosslinked rubber particles.

The crosslinked rubber powder preferably has a median diameter D50 of between 2 and 500 μm, preferably between 50 and 300 μm, and more preferentially between 60 and 200 μm.

The D90 diameter of the powder may notably be between 10 and 800 μm, preferably between 80 and 500 μm, and more preferentially between 100 and 300 μm.

The diameter D10 of the powder may notably be between 1 and 300 μm, preferably between 5 and 200 μm, and more preferentially between 10 and 100 μm.

The term “diameter” or “D” of the powder means the mass-average diameter of a pulverulent material, as measured by the “Ro-tap sieve tests” method using machines such as the RX-94 Duo or RO-TAP Premium sold by W. S. Tyler, equipped with sieves complying with the standard ISO 3310-1:2016.

Different diameters are distinguished. More specifically, D50 denotes the median diameter by mass, respectively the diameters below which 50% by mass of the particles are found. D10 and D90 also denote the diameters below which 10% or 90% by mass, respectively, of the particles are found.

For the purposes of the present description, the term “crosslinked rubber” means a crosslinked elastomer.

The rubber of the crosslinked rubber powder may be a natural or synthetic rubber or a mixture thereof.

The rubber used in manufacturing the rubber powder can be virtually any type of sulfur-vulcanized rubber compound and may come from a wide variety of sources. By way of example, mention may be made of bromobutyl rubber, butyl rubber, polyisoprene rubber, polynorbornene rubber, ethylene-propylene rubber (EPR), ethylene-propylene-diene rubber (EPDM), nitrile rubber, carboxylated nitrile rubber, polychloroprene rubber (neoprene rubber), polysulfide rubbers, polyacrylic rubbers, silicone rubbers, chlorosulfonated polyethylene rubbers, rubbers comprising polybutadiene, styrene-butadiene rubbers, and the like, and also various mixtures thereof.

The rubber of the crosslinked rubber powder may contain from 0 to 50% by weight, preferably from 5% to 40% by weight, of a synthetic rubber or a mixture of synthetic rubbers.

The rubber of the crosslinked rubber powder may contain from 10% to 80% by weight, preferably from 15% to 70% by weight, of natural rubber.

Natural rubber may notably be chosen from cis-1,4-polyisoprene or trans-1,4-polyisoprene.

The rubber of the rubber powder may contain a styrene-butadiene rubber, preferably in a content greater than 5% by weight, more preferentially greater than 10% by weight.

The crosslinked rubber powder may be derived from a variety of sources, notably from the recycling of industrial waste or finished objects after use. Such objects may come from a wide range of fields, such as in the clothing sector, notably shoe outsoles and boots; in the automotive sector, sealing parts such as gaskets, airbags, floor mats, anti-vibration supports and fittings; in industry, conveyor belts, belts, drinkable water seals, O-rings, cables and pipes; in consumer products, window seals, mattress foams, golf balls, tennis balls, windsurfing suits, masks and flippers; in the construction sector, anti-seismic bridges and posts, flexible tanks and profiles; in the hygiene and medical sectors: gloves and baby-bottle teats.

Crosslinked rubber powder is notably derived from the recycling of used products. This may notably involve used tires, notably at the end of their life and/or tires which have travelled at least 20 km. Recycled crosslinked rubber, notably derived from used tires, may comprise functions produced during thermo-oxidation reactions in a higher content than that observed in rubber that has never been used. These functions may notably be phenylhydrazone, carbonyl such as ketones, hydroxyl or sulfenic acid, advantageously carbonyl and sulfenic acid functions.

Without wishing to be bound by any particular theory, these polar functions may allow improved interactions between the TPE-based matrix and the crosslinked rubber powder particles, and thus the physical properties of the composite material.

As an example of a source of crosslinked rubber powder derived from used tires, mention may be made of the rubber compound recovered during the polishing of vehicle tire treads, in the context of regrooving procedures. However, as discussed above, the rubber compound may come from a wide variety of sources, including whole tires, tire sidewalls, tire inner liners, tire carcasses, power transmission belts, conveyor belts, pipes and a wide variety of other rubber products.

Consequently, the crosslinked rubber powder used in accordance with the present description is typically a powder of a mixture of natural rubber and synthetic rubbers such as polyisoprene synthetic rubber, polybutadiene rubber and styrene-butadiene rubber. However, the crosslinked rubber powder used in accordance with the invention may be a mixture of two or more of these rubbers, or it may be composed of a single type of rubber. For example, the crosslinked rubber powder may consist only of natural rubber, synthetic polyisoprene rubber, styrene-butadiene rubber, a mixture of natural rubber and polybutadiene rubber, or a mixture of natural rubber and styrene-butadiene rubber.

The crosslinked rubber powder may be prepared according to various methods. By way of example, the rubber powder may be obtained via a grinding process. Various grinding processes exist, for instance mechanical grinding at room temperature, cryogenic grinding, grinding using water jets, or powder micronization. Waterjet grinding, also known as waterjet chopping, is particularly preferred for used tires.

The crosslinked rubber powder may contain from 1% to 70%, preferably from 5% to 50%, more preferentially from 10% to 40% of carbon black and/or silica.

In one embodiment, the crosslinked rubber powder comprises carbon black and silica. Advantageously, the silica content is twice and very advantageously five times as large as the carbon black content, the content representing the weight content relative to the total weight of the composition.

Moreover, the crosslinked rubber powder may comprise less than 10%, advantageously less than 5% and very advantageously less than 1% of fibrous material.

Preferably, the composition does not comprise any glass fiber.

In addition, the crosslinked rubber powder may contain from 0.05% to 5% by weight, preferably from 0.1% to 2.5% by weight, of zinc oxide.

### Thermoplastic Elastomer (TPE)/Elastomeric Thermoplastic Copolymer

The term “thermoplastic elastomer” or “TPE” means polymers which combine the elastic properties of elastomers with a thermoplastic character, i.e. they melt and harden in a reversible manner under the action of heat. These thermoplastic elastomers may notably be mechanical polymer mixtures, i.e. a “polymer-polymer” mixture, usually a thermoplastic polymer and an elastomer. Alternatively, they may be thermoplastic elastomeric copolymers.

The term “thermoplastic elastomeric copolymer” means a polymer including flexible segments and rigid segments, for example in the form of a block copolymer, in which the rigid segments, which are generally semicrystalline or have a high glass transition temperature, melt or soften as the temperature rises. Above the melting point or glass transition temperature of the rigid segment domains, the material can be used in conventional thermoplastic polymer processing techniques. Below the melting point of the rigid segment domains, the thermoplastic elastomer has elastic properties close to those of crosslinked elastomers.

The flexible and rigid blocks are covalently bonded in the various elastomers by means of functions notably chosen from amides, esters, urethanes and ureas.

According to certain embodiments, the at least one TPE copolymer is chosen from polyamide elastomers, thermoplastic polyurethanes, polyester elastomers, styrene-butadiene block copolymers and styrene-ethylene-butadiene block copolymers, preferably from polyether block amides (PEBA), thermoplastic polyurethanes (TPU) and polyester elastomers.

According to another embodiment, the TPE copolymer advantageously comprises rigid blocks chosen from polyamides, polyurethanes and polyesters.

According to certain embodiments, the ratio of flexible blocks to rigid blocks is chosen so that the tensile modulus according to ISO 527 is between 5 and 800 MPa, preferably between 10 and 300 MPa, and more preferentially between 20 and 150 MPa.

According to certain embodiments, the TPE copolymer has a Shore hardness of between 10 D and 70 D, notably between 25 D and 45 D.

According to certain embodiments, the compositions comprise a mixture of TPE copolymer, notably a mixture of PEBA, TPU and/or thermoplastic polyester.

According to certain embodiments, the mixture is notably a TPE copolymer alloy. The term “alloy” means a mixture that is homogeneous (macroscopically, i.e. to the naked eye). In one embodiment, the various TPE copolymers are linked via one or more covalent bonds. The groups that are capable of linking the two TPE copolymers are chosen from urethanes, ureas, amides and esters.

By way of example, in the context of a TPU-PEBA alloy, the two copolymers TPU and PEBA may be linked via one or more covalent bonds.

In certain embodiments, at least a part of the polyamide block-polyether block copolymer is covalently bonded to at least a part of the thermoplastic polyurethane by a urethane function; preferably, an amount of less than or equal to 10% by weight, more preferentially less than or equal to 5% by weight, of the polyamide block-polyether block copolymer is covalently bonded to at least a part of the thermoplastic polyurethane by a urethane function.

### [PEBA]

The copolymer is notably a thermoplastic polyamide, in particular a PEBA copolymer.

PEBAs result from the polycondensation of polyamide blocks (rigid or hard blocks) bearing reactive ends with polyether blocks (flexible or soft blocks) bearing reactive ends, such as, inter alia, the polycondensation:
1) of polyamide blocks bearing diamine chain ends with polyoxyalkylene blocks bearing dicarboxylic chain ends;
2) of polyamide blocks bearing dicarboxylic chain ends with polyetherdiols (α,ω-dihydroxylated aliphatic polyoxyalkylene blocks), the products obtained being, in this particular case, polyetheresteramides.

The polyamide blocks bearing dicarboxylic chain ends originate, for example, from the condensation of polyamide precursors in the presence of a chain-limiting dicarboxylic acid. The polyamide blocks bearing diamine chain ends originate, for example, from the condensation of polyamide precursors in the presence of a chain-limiting diamine.

Three types of polyamide blocks may advantageously be used.

According to a first type, the polyamide blocks originate from the condensation of a dicarboxylic acid, in particular those containing from 4 to 36 carbon atoms, preferably those containing from 4 to 20 carbon atoms, more preferentially from 6 to 18 carbon atoms, and of an aliphatic or aromatic diamine, in particular those containing from 2 to 20 carbon atoms, preferably those containing from 6 to 14 carbon atoms.

As examples of dicarboxylic acids, mention may be made of 1,4-cyclohexanedicarboxylic acid, butanedioic acid, adipic acid, azelaic acid, suberic acid, sebacic acid, dodecanedicarboxylic acid, octadecanedicarboxylic acid, terephthalic acid and isophthalic acid, but also dimerized fatty acids.

As examples of diamines, mention may be made of tetramethylenediamine, hexamethylenediamine, 1,10-decamethylenediamine, dodecamethylenediamine, trimethylhexamethylenediamine, the isomers of bis(4-aminocyclohexyl)methane (BACM), bis(3-methyl-4-aminocyclohexyl)methane (BMACM) and 2,2-bis(3-methyl-4-aminocyclohexyl)propane (BMACP), para-aminodicyclohexylmethane (PACM), isophoronediamine (IPDA), 2,6-bis(aminomethyl)norbornane (BAMN) and piperazine (Pip).

Advantageously, polyamide blocks PA 4.12, PA 4.14, PA 4.18, PA 6.10, PA 6.12, PA 6.14, PA 6.18, PA 9.12, PA 10.10, PA 10.12, PA 10.14 and PA 10.18 are used. In the notation PA X.Y, X represents the number of carbon atoms derived from the diamine residues and Y represents the number of carbon atoms derived from the diacid residues, as is conventional.

According to a second type, the polyamide blocks result from the condensation of one or more α,ω-aminocarboxylic acids and/or of one or more lactams containing from 6 to 12 carbon atoms in the presence of a dicarboxylic acid containing from 4 to 18 carbon atoms or of a diamine. As examples of lactams, mention may be made of caprolactam, oenantholactam and lauryllactam. As examples of α,ω-aminocarboxylic acids, mention may be made of aminocaproic acid, 7-aminoheptanoic acid, 10-aminodecanoic acid, 11-aminoundecanoic acid and 12-aminododecanoic acid.

Advantageously, the polyamide blocks of the second type are PA 10 (polydecanamide), PA 11 (polyundecanamide), PA 12 (polydodecanamide) or PA 6 (polycaprolactam) blocks. In the notation PA X, X represents the number of carbon atoms derived from amino acid residues.

According to a third type, the polyamide blocks result from the condensation of at least one α,ω-aminocarboxylic acid (or a lactam), at least one diamine and at least one dicarboxylic acid.

In this case, the polyamide PA blocks are prepared by polycondensation:
of the linear aliphatic or aromatic diamine(s) containing X carbon atoms;
of the dicarboxylic acid(s) containing Y carbon atoms; and
of the comonomer(s) {Z}, chosen from lactams and α,ω-aminocarboxylic acids containing Z carbon atoms and equimolar mixtures of at least one diamine containing X1 carbon atoms and of at least one dicarboxylic acid containing Y1 carbon atoms, (X1, Y1) being different from (X, Y);
said comonomer(s) {Z}being introduced in a weight proportion advantageously ranging up to 50%, preferably up to 20%, even more advantageously up to 10% relative to the total amount of polyamide-precursor monomers;
in the presence of a chain limiter chosen from dicarboxylic acids.

Advantageously, the dicarboxylic acid containing Y carbon atoms is used as chain limiter, which is introduced in excess relative to the stoichiometry of the diamine(s).

According to one variant of this third type, the polyamide blocks result from the condensation of at least two α,ω-aminocarboxylic acids or of at least two lactams containing from 6 to 12 carbon atoms or of one lactam and one aminocarboxylic acid not having the same number of carbon atoms, in the optional presence of a chain limiter.

As examples of aliphatic α,ω-aminocarboxylic acids, mention may be made of aminocaproic acid, 7-aminoheptanoic acid, 10-aminodecanoic acid, 11-aminoundecanoic acid and 12-aminododecanoic acid. As examples of lactams, mention may be made of caprolactam, oenantholactam and lauryllactam. As examples of aliphatic diamines, mention may be made of hexamethylenediamine, dodecamethylenediamine and trimethylhexamethylenediamine.

As examples of cycloaliphatic diacids, mention may be made of 1,4-cyclohexanedicarboxylic acid. As examples of aliphatic diacids, mention may be made of butanedioic acid, adipic acid, azelaic acid, suberic acid, sebacic acid, dodecanedicarboxylic acid and dimerized fatty acids. These dimerized fatty acids preferably have a dimer content of at least 98%; they are preferably hydrogenated; they are, for example, products sold under the brand name Pripol by the company Croda, or under the brand name Empol by the company BASF, or under the brand name Radiacid by the company Oleon, and polyoxyalkylene α,ω-diacids. As examples of aromatic diacids, mention may be made of terephthalic acid (T) and isophthalic acid (I).

As examples of cycloaliphatic diamines, mention may be made of the isomers of bis(4-aminocyclohexyl)methane (BACM), bis(3-methyl-4-aminocyclohexyl)methane (BMACM) and 2,2-bis(3-methyl-4-aminocyclohexyl)propane (BMACP), and para-aminodicyclohexylmethane (PACM). The other diamines commonly used may be isophoronediamine (IPDA), 2,6-bis(aminomethyl)norbornane (BAMN) and piperazine.

As examples of polyamide blocks of the third type, mention may be made of the following:
PA 6.6/6, in which 6.6 denotes hexamethylenediamine units condensed with adipic acid and 6 denotes units resulting from the condensation of caprolactam;
PA 6.6/6.10/11/12, where 6.6 denotes hexamethylenediamine condensed with adipic acid, 6.10 denotes hexamethylenediamine condensed with sebacic acid, 11 denotes units resulting from the condensation of aminoundecanoic acid and 12 denotes units resulting from the condensation of lauryllactam.

The notations PA X/Y, PA X/Y/Z, etc. relate to copolyamides in which X, Y, Z, etc. represent homopolyamide units as described above.

Advantageously, the polyamide blocks of the copolymer used in the invention comprise polyamide PA 6, PA 10, PA 11, PA 12, PA 5.4, PA 5.9, PA 5.10, PA 5.12, PA 5.13, PA 5.14, PA 5.16, PA 5.18, PA 5.36, PA 6.4, PA 6.6, PA 6.9, PA 6.10, PA 6.12, PA 6.13, PA 6.14, PA 6.16, PA 6.18, PA 6.36, PA 10.4, PA 10.9, PA 10.10, PA 10.12, PA 10.13, PA 10.14, PA 10.16, PA 10.18, PA 10.36, PA 10.T, PA 12.4, PA 12.9, PA 12.10, PA 12.12, PA 12.13, PA 12.14, PA 12.16, PA 12.18, PA 12.36 or PA 12.T blocks, or mixtures or copolymers thereof; and preferably comprise polyamide PA 6, PA 10, PA 11, PA 12, PA 6.10, PA 6.12, PA 10.10 or PA 10.12 blocks, or mixtures or copolymers thereof, more preferentially polyamide PA 11, PA 12, PA 6 or PA 6.12 blocks, or mixtures or copolymers thereof.

The polyether blocks are formed from alkylene oxide units.

The polyether blocks may notably be PEG (polyethylene glycol) blocks, i.e. blocks formed from ethylene oxide units, and/or PPG (propylene glycol) blocks, i.e. blocks formed from propylene oxide units, and/or PO3G (polytrimethylene glycol) blocks, i.e. blocks formed from polytrimethylene glycol ether units, and/or PTMG blocks, i.e. blocks formed from tetramethylene glycol units, also known as polytetrahydrofuran. The PEBA copolymers may comprise in their chain several types of polyethers, the copolyethers possibly being in block or statistical form.

Use may also be made of blocks obtained by oxyethylation of bisphenols, for instance bisphenol A. The latter products are notably described in EP 613 919.

The polyether blocks may also consist of ethoxylated primary amines. As examples of ethoxylated primary amines, mention may be made of the products of formula:

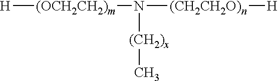

in which m and n are integers between 1 and 20 and x is an integer between 8 and 18. These products are commercially available, for example, under the brand name Noramox® from the company CECA and under the brand name Genamin® from the company Clariant.

Polyetherdiol blocks are copolycondensed with carboxy-terminated polyamide blocks. The general method for the two-step preparation of PEBA copolymers containing ester bonds between the PA blocks and the PE blocks is known and is described, for example, in FR 2846332. The general method for preparing PEBA copolymers bearing amide bonds between the PA blocks and the PE blocks is known and described, for example in EP 1482011. The polyether blocks may also be mixed with polyamide precursors and a chain-limiting diacid to prepare polymers containing polyamide blocks and polyether blocks having randomly distributed units (one-step process).

PEBA may comprise amine chain ends, with the proviso that it comprises OH chain ends. PEBAs comprising amine chain ends may result from the polycondensation of polyamide blocks bearing dicarboxylic chain ends with polyoxyalkylene blocks bearing diamine chain ends, obtained, for example, by cyanoethylation and hydrogenation of α,ω-dihydroxylated aliphatic polyoxyalkylene blocks, known as polyetherdiols.

Needless to say, the name PEBA in the present description of the invention relates not only to the Pebax® products sold by Arkema, to the Vestamid® products sold by Evonik® and to the Grilamid® products sold by EMS, but also to the Pelestat® PEBA-type products sold by Sanyo or to any other PEBA from other suppliers.

Whereas the block copolymers described above generally comprise at least one polyamide block and at least one polyether block, the present invention also covers copolymers comprising two, three, four (or even more) different blocks chosen from those described in the present description, provided that these blocks include at least polyamide and polyether blocks.

For example, the copolymer according to the invention may be a segmented block copolymer comprising three different types of blocks (or “triblock” copolymer), which results from the condensation of several of the blocks described above. Said triblock may be, for example, a copolymer comprising a polyamide block, a polyester block and a polyether block or a copolymer comprising a polyamide block and two different polyether blocks, for example a PEG block and a PTMG block. The triblock is preferably a copolyetheresteramide.

PEBA copolymers that are particularly preferred in the context of the invention are copolymers including blocks from among: PA 10 and PEG; PA 10 and PTMG; PA 11 and PEG; PA 11 and PTMG; PA 12 and PEG; PA 12 and PTMG; PA 6.10 and PEG; PA 6.10 and PTMG; PA 6 and PEG; PA 6 and PTMG; PA 6.12 and PEG; PA 6.12 and PTMG.

The number-average molar mass of the polyamide blocks in the PEBA copolymer is preferably from 400 to 20 000 g/mol, more preferentially from 500 to 10 000 g/mol. In certain embodiments, the number-average molar mass of the polyamide blocks in the PEBA copolymer is from 400 to 500 g/mol, or from 500 to 600 g/mol, or from 600 to 1000 g/mol, or from 1000 to 1500 g/mol, or from 1500 to 2000 g/mol, or from 2000 to 2500 g/mol, or from 2500 to 3000 g/mol, or from 3000 to 3500 g/mol, or from 3500 to 4000 g/mol, or from 4000 to 5000 g/mol, or from 5000 to 6000 g/mol, or from 6000 to 7000 g/mol, or from 7000 to 8000 g/mol, or from 8000 to 9000 g/mol, or from 9000 to 10 000 g/mol, or from 10 000 to 11 000 g/mol, or from 11 000 to 12 000 g/mol, or from 12 000 to 13 000 g/mol, or from 13 000 to 14 000 g/mol, or from 14 000 to 15 000 g/mol, or from 15 000 to 16 000 g/mol, or from 16 000 to 17 000 g/mol, or from 17 000 to 18 000 g/mol, or from 18 000 to 19 000 g/mol, or from 19 000 to 20 000 g/mol.

The number-average molar mass of the polyether blocks is preferably from 100 to 6000 g/mol, more preferentially from 200 to 3000 g/mol. In certain embodiments, the number-average molar mass of the polyether blocks is from 100 to 200 g/mol, or from 200 to 500 g/mol, or from 500 to 800 g/mol, or from 800 to 1000 g/mol, or from 1000 to 1500 g/mol, or from 1500 to 2000 g/mol, or from 2000 to 2500 g/mol, or from 2500 to 3000 g/mol, or from 3000 to 3500 g/mol, or from 3500 to 4000 g/mol, or from 4000 to 4500 g/mol, or from 4500 to 5000 g/mol, or from 5000 to 5500 g/mol, or from 5500 to 6000 g/mol.

The number-average molar mass is set by the content of chain limiter. It may be calculated according to the equation:

$${M}_{n} = {n}_{monomer} \times M {W}_{repeating unit} / {n}_{chain limiter} + M {W}_{chain limiter}$$

In this formula, nₘₒₙₒₘₑᵣ represents the number of moles of monomer, n_{chain limiter} represents the number of moles of diacid limiter in excess, MW_{repeating unit} represents the molar mass of the repeating unit, and MW_{chain limiter} represents the molar mass of the diacid in excess.

The number-average molar mass of the polyamide blocks and of the polyether blocks can be measured before the copolymerization of the blocks by gel permeation chromatography (GPC).

Advantageously, the mass ratio of the polyamide blocks relative to the polyether blocks of the copolymer is from 0.1 to 20, preferably from 0.5 to 18, even more preferentially from 0.6 to 15. This mass ratio may be calculated by dividing the number-average molar mass of the polyamide blocks by the number-average molar mass of the polyether blocks. In particular, the mass ratio of the polyamide blocks relative to the polyether blocks of the copolymer may be from 0.1 to 0.2, or from 0.2 to 0.3, or from 0.3 to 0.4, or from 0.4 to 0.5, or from 0.5 to 0.6, or from 0.6 to 0.7, or from 0.7 to 0.8, or from 0.8 to 0.9, or from 0.9 to 1, or from 1 to 1.5, or from 1.5 to 2, or from 2 to 2.5, or from 2.5 to 3, or from 3 to 3.5, or from 3.5 to 4, or from 4 to 4.5, or from 4.5 to 5, or from 5 to 5.5, or from 5.5 to 6, or from 6 to 6.5, or from 6.5 to 7, or from 7 to 7.5, or from 7.5 to 8, or from 8 to 8.5, or from 8.5 to 9, or from 9 to 9.5, or from 9.5 to 10, or from 10 to 11, or from 11 to 12, or from 12 to 13, or from 13 to 14, or from 14 to 15, or from 15 to 16, or from 16 to 17, or from 17 to 18, or from 18 to 19, or from 19 to 20.

Advantageously, the polyamide block-polyether block copolymer has a Shore D hardness greater than or equal to 30. Preferably, the at least one copolymer used in the invention has an instantaneous Shore hardness of between 10 D and 70 D, preferably between 25 D and 50 D. Hardness measurements may be performed according to the standard ISO 7619-1.

Advantageously, the PEBA according to the invention has an OH function concentration of from 0.002 meq/g to 0.2 meq/g, preferably from 0.005 meq/g to 0.1 meq/g, more preferably from 0.01 meq/g to 0.08 meq/g and/or a COOH function concentration of from 0.002 meq/g to 0.2 meq/g, preferably from 0.005 meq/g to 0.1 meq/g, more preferably from 0.01 meq/g to 0.08 meq/g. In particular, the PEBA according to the invention may have an OH function concentration of from 0.002 to 0.005 meq/g, or from 0.005 to 0.01 meq/g, or from 0.01 to 0.02 meq/g, or from 0.02 to 0.03 meq/g, or from 0.03 to 0.04 meq/g, or from 0.04 to 0.05 meq/g, or from 0.05 to 0.06 meq/g, or from 0.06 to 0.07 meq/g, or from 0.07 to 0.08 meq/g, or from 0.08 to 0.09 meq/g, or from 0.09 to 0.1 meq/g, or from 0.1 to 0.15 meq/g, or from 0.15 to 0.2 meq/g, and/or have a COOH function concentration of from 0.002 to 0.005 meq/g, or from 0.005 to 0.01 meq/g, or from 0.01 to 0.02 meq/g, or from 0.02 to 0.03 meq/g, or from 0.03 to 0.04 meq/g, or from 0.04 to 0.05 meq/g, or from 0.05 to 0.06 meq/g, or from 0.06 to 0.07 meq/g, or from 0.07 to 0.08 meq/g, or from 0.08 to 0.09 meq/g, or from 0.09 to 0.1 meq/g, or from 0.1 to 0.15 meq/g, or from 0.15 to 0.2 meq/g. The COOH function concentration may be determined by potentiometric analysis, and the OH function concentration may be determined by proton NMR. Measurement protocols are detailed in the article “Synthesis and characterization of poly(copolyether-block-polyamides)—II. Characterization and properties of multiblock copolymers”, Marechal et al., Polymer, Volume 41, 2000, 3561-3580.

Preferably, the polyamide blocks of the polyamide block-polyether block copolymer are blocks of polyamide 11, polyamide 12, polyamide 10, polyamide 6, polyamide 6.10, polyamide 6.12, polyamide 10.10 and/or polyamide 10.12, preferably polyamide 11, polyamide 12, polyamide 6 and/or polyamide 6.12; and/or the polyether blocks of the polyamide block-polyether block copolymer are polyethylene glycol and/or polytetrahydrofuran blocks.

### [TPU]

According to a variant, the rigid block is a polyurethane comprising at least one XY unit:
X being a polyisocyanate,
Y being a chain extender.

The TPE copolymer is thus notably a thermoplastic polyurethane (TPU).

For the purposes of the present description, the thermoplastic polyurethane is a copolymer containing rigid blocks and flexible blocks. Thermoplastic polyurethanes result from the reaction of at least one polyisocyanate (X) with at least one isocyanate-reactive compound, preferably containing two isocyanate-reactive functional groups, more preferentially a polyol, and optionally with a chain extender, optionally in the presence of a catalyst.

The rigid TPU blocks are blocks consisting of units derived from polyisocyanates and chain extenders, while the flexible blocks predominantly comprise units derived from isocyanate-reactive compounds having a molar mass of between 0.5 and 100 kg/mol, preferably polyols.

The polyisocyanate may be aliphatic, cycloaliphatic, araliphatic and/or aromatic. Preferably, the polyisocyanate is a diisocyanate.

Advantageously, the polyisocyanate is chosen from the group consisting of tri-, tetra-penta-, hexa-, hepta- and/or octamethylene-diisocyanate, 2-methylpentamethylene-1,5-diisocyanate, 2-ethylbutylene-1,4-diisocyanate, 1,5-pentamethylene-diisocyanate, 1,4-butylene-diisocyanate, 1-isocyanato-3,3,5-trimethyl-5-isocyanatomethylcyclohexane (isophorone-diisocyanate, IPDI), 1,4-bis(isocyanatomethyl)cyclohexane, 1,3-bis(isocyanatomethyl)cyclohexane (HXDI), 2,4-paraphenylene-diisocyanate (PPDI), 2,4-tetramethylenexylene-diisocyanate (TMXDI), 4,4′-, 2,4′- and/or 2,2′-dicyclohexylmethane-diisocyanate (H12 MDI), 1,4-cyclohexane-diisocyanate, 1-methyl-2,4- and/or 1-methyl-2,6-cyclohexane-diisocyanate, 2,2′-, 2,4′- and/or 4,4′-diphenylmethane-diisocyanate (MDI), 1,5-naphthylene-diisocyanate (NDI), 2,4- and/or 2,6-toluene-diisocyanate (TDI), diphenylmethane-diisocyanate, 3,3′-dimethyldiphenyl-diisocyanate, 1,2-diphenylethane-diisocyanate, phenylene-diisocyanate, methylenebis(4-cyclohexylisocyanate) (HMDI) and mixtures thereof.

More preferably, the polyisocyanate is chosen from the group consisting of diphenylmethane-diisocyanates (MDI), toluene-diisocyanates (TDI), pentamethylene-diisocyanate (PDI), hexamethylene-diisocyanate (HDI), methylenebis(4-cyclohexylisocyanate) (HMDI) and mixtures thereof.

Even more preferably, the polyisocyanate is 4,4′-MDI (4,4′-diphenylmethane-diisocyanate), 1,6-HDI (1,6-hexamethylene-diisocyanate) or a mixture thereof.

The isocyanate-reactive compound(s) preferably have an average functionality of between 1.8 and 3, more preferably between 1.8 and 2.6, more preferentially between 1.8 and 2.2. The average functionality of the isocyanate-reactive compound(s) corresponds to the number of isocyanate-reactive functions of the molecules, calculated theoretically for one molecule from an amount of compounds. Preferably, the isocyanate-reactive compound has, according to a statistical average, a Zerewitinoff active hydrogen number in the above ranges.

Preferably, the isocyanate-reactive compound (preferably a polyol) has a number-average molar mass of from 500 to 100 000 g/mol. The isocyanate-reactive compound may have a number-average molar mass ranging from 500 to 8000 g/mol, preferably from 700 to 6000 g/mol, more particularly from 800 to 4000 g/mol.

In certain embodiments, the isocyanate-reactive compound has a number-average molar mass ranging from 500 to 600 g/mol, or from 600 to 700 g/mol, or from 700 to 800 g/mol, or from 800 to 1000 g/mol, or 1000 to 1500 g/mol, or 1500 to 2000 g/mol, or 2000 to 2500 g/mol, or 2500 to 3000 g/mol, or 3000 to 3500 g/mol, or from 3500 to 4000 g/mol, or from 4000 to 5000 g/mol, or from 5000 to 6000 g/mol, or from 6000 to 7000 g/mol, or from 7000 to 8000 g/mol, or from 8000 to 10 000 g/mol, or from 10 000 to 15 000 g/mol, or from 15 000 to 20 000 g/mol, or from 20 000 to 30 000 g/mol, or from 30 000 to 40 000 g/mol, or from 40 000 to 50 000 g/mol, or from 50 000 to 60 000 g/mol, or from 60 000 to 70 000 g/mol, or from 70 000 to 80 000 g/mol, or from 80 000 to 100 000 g/mol. The number-average molar mass may be determined by GPC, preferably according to the standard ISO 16014-1:2012.

Advantageously, the isocyanate-reactive compound has at least one reactive group chosen from hydroxyl, amine, thiol and carboxylic acid groups. Preferably, the isocyanate-reactive compound has at least one hydroxyl reactive group, more preferentially several hydroxyl groups. Thus, in a particularly advantageous manner, the isocyanate-reactive compound comprises or consists of a polyol.

Preferably, the polyol is chosen from the group consisting of polyester polyols, polyether polyols, polycarbonate diols, polysiloxane diols, polyalkylene diols and mixtures thereof. More preferably, the polyol is a polyether polyol, polyester polyol and/or polycarbonate diol, so that the flexible blocks of the thermoplastic polyurethane are polyether blocks, polyester blocks and/or polycarbonate blocks, respectively. Preferably also, the flexible blocks of the thermoplastic polyurethane are polyether blocks and/or polyester blocks (the polyol being a polyether polyol and/or a polyester polyol).

As polyester polyols, mention may be made of polycaprolactone polyols and/or copolyesters based on one or more carboxylic acids chosen from adipic acid, succinic acid, pentanedioic acid and/or sebacic acid and one or more alcohols chosen from 1,2-ethanediol, 1,3-propanediol, 1,4-butanediol, 1,5-pentanediol, 3-methyl-1,5-pentanediol, 1,6-hexanediol and/or polytetrahydrofuran.

More particularly, the copolyester may be based on adipic acid and a mixture of 1,2-ethanediol and 1,4-butanediol, or the copolyester may be based on adipic acid, succinic acid, pentanedioic acid, sebacic acid or mixtures thereof, and polytetrahydrofuran (tetramethylene glycol), or the copolyester may be a mixture of these copolyesters.

As polyether polyol, polyetherdiols (i.e. aliphatic α,ω-dihydroxylated polyoxyalkylene blocks) are preferably used. Preferably, the polyether polyol is a polyetherdiol based on ethylene oxide, propylene oxide, and/or butylene oxide, a block copolymer based on ethylene oxide and propylene oxide, polyethylene glycol, polypropylene glycol, polybutylene glycol, polytetrahydrofuran, polybutanediol or a mixture thereof.

The polyether polyol is preferably a polytetrahydrofuran (flexible blocks of the thermoplastic polyurethane thus being polytetrahydrofuran blocks) and/or a polypropylene glycol (flexible blocks of the thermoplastic polyurethane thus being polypropylene glycol blocks) and/or a polyethylene glycol (flexible blocks of the thermoplastic polyurethane thus being polyethylene glycol blocks), preferably a polytetrahydrofuran having a number-average molar mass of from 500 to 15 000 g/mol, preferably from 1000 to 3000 g/mol. The polyether polyol may be a polyether diol which is the product of reaction of ethylene oxide and propylene oxide; the mole ratio of ethylene oxide to propylene oxide is preferably from 0.01 to 100, more preferentially from 0.1 to 9, more preferentially from 0.25 to 4, more preferentially from 0.4 to 2.5, more preferentially from 0.6 to 1.5 and is more preferentially 1.

The polysiloxane diols that may be used in the invention preferably have a number-average molar mass of from 500 to 15 000 g/mol, preferably from 1000 to 3000 g/mol. The number-average molar mass may be determined by GPC, preferably according to the standard ISO 16014-1:2012. Advantageously, the polysiloxane diol is a polysiloxane of formula (I):

HO—[R—O]ₙ—R—Si(R′)₂—[O—Si(R′)₂]ₘ—O—Si(R′)₂—R—[O—R]ₚ—OH (I)
in which R is preferably a C₂-C₄ alkylene, R′ is preferably a C₁-C₄ alkyl and each of n, m and p independently represents an integer preferably between 0 and 50, m ranging more preferentially from 1 to 50, even more preferentially from 2 to 50. Preferably, the polysiloxane has the formula (II) below:

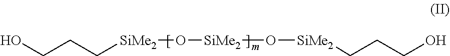

in which Me is a methyl group,
or the formula (III) below:

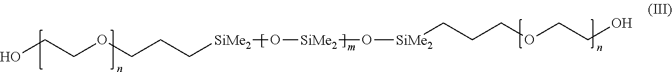

The polyalkylene diols that may be used in the invention are preferably butadiene-based.

The polycarbonate diols that may be used in the invention are preferably aliphatic polycarbonate diols. The polycarbonate diol is preferably alkanediol-based. Preferably, it is strictly difunctional. The preferred polycarbonate diols according to the invention are those based on butanediol, pentanediol and/or hexanediol, in particular 1,4-butanediol, 1,5-pentanediol, 1,6-hexanediol, 3-methylpentane-(1,5)-diol, or mixtures thereof, more preferentially based on 1,4-butanediol, 1,5-pentanediol, 1,6-hexanediol, or mixtures thereof. In particular, the polycarbonate diol may be a polycarbonate diol based on butanediol and hexanediol, or based on pentanediol and hexanediol, or based on hexanediol, or may be a mixture of two or more of these polycarbonate diols. The polycarbonate diol advantageously has a number-average molar mass ranging from 500 to 4000 g/mol, preferably from 650 to 3500 g/mol, more preferentially from 800 to 3000 g/mol. The number-average molar mass may be determined by GPC, preferably according to the standard ISO 16014-1:2012.

One or more polyols may be used as isocyanate-reactive compounds.

In a particularly preferred manner, the flexible blocks of the TPU are polytetrahydrofuran, polypropylene glycol and/or polyethylene glycol blocks.

Preferably, a chain extender (Y) is used for the preparation of the thermoplastic polyurethane, in addition to the isocyanate and the isocyanate-reactive compound.

The chain extender may be aliphatic, araliphatic, aromatic and/or cycloaliphatic.

Advantageously, it has a number-average molar mass of from 50 to 499 g/mol. The number-average molar mass may be determined by GPC, preferably according to the standard ISO 16014-1:2012. The chain extender preferably has two isocyanate-reactive groups (also known as “functional groups”).

A single chain extender or a mixture of at least two chain extenders may be used.

The chain extender is preferably difunctional. Examples of chain extenders are diamines and alkanediols containing from 2 to 10 carbon atoms. In particular, the chain extender may be chosen from the group consisting of 1,2-ethylene glycol, 1,2-propanediol, 1,3-propanediol, 1,4-butanediol, 2,3-butanediol, 1,5-pentanediol, 1,6-hexanediol, diethylene glycol, dipropylene glycol, 1,4-cyclohexanediol, 1,4-dimethanolcyclohexane, neopentyl glycol, hydroquinonebis(beta-hydroxyethyl) ether (HQEE), di-, tri-, tetra-, penta-, hexa-, hepta-, octa-, nona- and/or deca-alkylene glycol, their respective oligomers, polypropylene glycol and mixtures thereof. More preferentially, the chain extender is chosen from the group consisting of 1,2-ethylene glycol, 1,3-propanediol, 1,4-butanediol, 1,5-pentanediol, 1,6-hexanediol, and mixtures thereof, and more preferably is chosen from 1,3-propanediol, 1,4-butanediol and/or 1,6-hexanediol. Even more preferentially, the chain extender is a mixture of 1,4-butanediol and 1,6-hexanediol, more preferentially in a mole ratio of from 6:1 to 10:1.

Advantageously, the TPU is semicrystalline. Its melting point Tf is preferably between 100° C. and 230° C., and more preferably between 120° C. and 160° C. The melting point may be measured according to the standard ISO 11357-3 Plastics—Differential scanning calorimetry (DSC) Part 3.

Advantageously, the TPU may be a recycled TPU and/or a partially or totally biobased TPU.

Preferably, the TPU has a Shore D hardness of less than or equal to 75, more preferentially less than or equal to 65. In particular, the TPU used in the invention may have a hardness of 65 Shore A to 70 Shore D, preferably 75 Shore A to 60 Shore D. The hardness measurements may be performed according to the standard ISO 7619-1.

Advantageously, the TPU according to the invention has an OH function concentration of from 0.002 meq/g to 0.6 meq/g, preferably from 0.01 meq/g to 0.4 meq/g, more preferably from 0.03 meq/g to 0.2 meq/g. In certain embodiments, the TPU according to the invention has an OH function concentration of from 0.002 to 0.005 meq/g, or from 0.005 to 0.01 meq/g, or from 0.01 to 0.02 meq/g, or from 0.02 to 0.04 meq/g, or from 0.04 to 0.06 meq/g, or from 0.06 to 0.08 meq/g, or from 0.08 to 0.1 meq/g, or from 0.1 to 0.2 meq/g, or from 0.2 to 0.3 meq/g, or from 0.3 to 0.4 meq/g, or from 0.4 to 0.5 meq/g, or from 0.5 to 0.6 meq/g. The OH function concentration may be determined by NMR under the conditions described in the article below: “Reactivity of isocyanates with urethanes: Conditions for allophanate formation”, Lapprand et al., Polymer Degradation and Stability, Volume 90, No. 2, 2005, 363-373.

Advantageously, the rigid polyurethane block is composed of a diisocyanate chosen from 4,4′-MDI, HDI or PDI and/or a diol chosen from butanediol, propanediol, pentanediol and hexanediol.

### [Thermoplastic Polyester]

As a variant, the rigid block is a polyester comprising at least one XY unit:
X being a dicarboxylic acid,
Y being a diol.

The thermoplastic copolyester elastomer comprises hard segments consisting of polyester repeating units derived from at least one aliphatic diol and at least one aromatic dicarboxylic acid or ester thereof, and soft segments chosen from the group consisting of aliphatic polyether, aliphatic polyester, aliphatic polycarbonate, dimer fatty acids and dimer fatty diols and combinations thereof.

The aliphatic diols generally contain from 2 to 10 carbon atoms, preferably from 2 to 6 carbon atoms. Among these diols, mention may be made of ethylene glycol, 1,2-propylene glycol, 1,3-propylene glycol, butylene glycol, 1,2-hexanediol, 1,6-hexamethylenediol, 1,4-butanediol, 1,4-cyclohexanediol, 1,4-cyclohexanedimethanol and mixtures thereof. Preferably, 1,4-butanediol is used. Suitable aromatic dicarboxylic acids include terephthalic acid, isophthalic acid, phthalic acid, 2,6-naphthalenedicarboxylic acid and 4,4′-diphenyldicarboxylic acid, and mixtures thereof. A mixture of 4,4′-diphenyldicarboxylic acid and 2,6-naphthalenedicarboxylic acid or a mixture of 4,4′-diphenyldicarboxylic acid and terephthalic acid is also very suitable for use. The mixture ratio between 4,4′-diphenyldicarboxylic acid and 2,6-naphthalenedicarboxylic acid or between 4,4′-diphenyldicarboxylic acid and terephthalic acid is preferably chosen between 40:60-60:40 on a weight basis so as to optimize the melting point of the thermoplastic copolyester.

The hard segment preferably has a repeating unit chosen from the group consisting of ethylene terephthalate (PET), propylene terephthalate (PPT), butylene terephthalate (PBT), polyethylene bibenzoate, polyethylene naphthalate, polybutylene bibenzoate, polybutylene naphthalate, polypropylene bibenzoate and polypropylene naphthalate, and combinations thereof. Preferably, the hard segment is butylene terephthalate (PBT), since thermoplastic copolyester elastomers comprising PBT hard segments have favorable crystallization behavior and a high melting point, resulting in a thermoplastic copolyester elastomer with good elastic properties and excellent thermal and chemical resistance.

In one preferred embodiment, the composition comprises a thermoplastic copolyester elastomer having rigid and flexible segments, in which the rigid segment is chosen from PBT or PET, preferably PBT, and the flexible segment is chosen from the group consisting of polybutylene adipate (PBA), polyethylene oxide (PEG), polypropylene oxide (PPG), polytetramethylene oxide (PTMG), PEO-PPO-PEO and combinations thereof, preferably PTMO, as this provides an article with low densities. In another preferred embodiment, the composition comprises a copolyether-ester thermoplastic elastomer composed of PBT and PTMG.

Advantageously, the rigid polyester block is a polymer of terephthalic acid and butanediol.

### The Additives

According to one embodiment, the composition also comprises from 0 to 5% by weight, preferably from 0.1% to 2% by weight, of additives relative to the total weight of the composition.

The additive may notably be chosen from a catalyst, an antioxidant, a thermal stabilizer, a UV stabilizer, a light stabilizer, a lubricant, a flame retardant, a nucleating agent, a chain extender and a dye.

### The Compatibilizers

According to one embodiment, the composition comprises from 0 to 5%, from 5% to 10%, from 10% to 15%, from 15% to 20%, from 20% to 25%, from 25% to 30%, from 30% to 35% or from 25% to 40% by weight of compatibilizers relative to the total weight of the composition.

Specifically, depending on the nature of the TPE and the rubber powder, the presence of a compatibilizer may be advantageous for obtaining good dispersion of the crosslinked rubber powder particles within the TPE matrix.

The term “compatibilizer” means an agent promoting compatibilization of the TPE matrix and the crosslinked rubber particles. This may notably refer to molecules, macromolecules, polymers or copolymers having good affinity with both the TPE matrix and the crosslinked rubber powder, which can thus promote physical cohesion between the various constituents of the composition or form a chemical bond with the matrix and/or the powder.

The physical cohesion may result, for example, from coating of the crosslinked rubber particles, entanglement of the polymer and/or copolymer chains and/or Van der Vaals or hydrogen bonds between all or part of the constituents of the composition.

In certain embodiments, at least part of the thermoplastic elastomer is covalently bonded to at least part of the compatibilizer via a urea, urethane, amide, ester or alkoxysilane function. Preferably an amount of less than or equal to 10% by weight, more preferentially less than or equal to 5% by weight, of the thermoplastic elastomer is covalently bonded to at least a part of the compatibilizer via a urea, urethane, amide, ester or alkoxysilane function.

The compatibilizer advantageously bears reactive functions which can preferably react with the alcohol, amine or carboxylic acid functions borne by the thermoplastic elastomer.

The composition according to the invention may comprise one or more compatibilizers chosen from copolyamides, impact modifiers, thermoplastic polyurethanes (TPU), polymers containing silane groups, siloxanes, or a mixture thereof.

### [Copolyamides]

According to certain embodiments, the compatibilizers may be chosen from copolyamides. Preferably, the copolyamide comprises at least X/YZ units or YZ/Y2Z2 units,
X being an amino acid or a lactam with a carbon number of between 6 and 18 and advantageously between 6 and 12,
Y and Y2 being a diamine with a carbon number of between 2 and 48 and advantageously between 2 and 36,
Z and Z2 being a dicarboxylic acid with a carbon number of between 6 and 48 and advantageously between 6 and 36.

In certain embodiments, the copolyamide comprises fatty acid dimer with a carbon number of between 18 and 48 and advantageously between 36 and 48.

### [Impact Modifier]

According to certain embodiments, the compatibilizers may be chosen from compounds known as impact modifiers, which may be functionalized or non-functionalized.

The term “impact modifier” means a polymer with a modulus lower than that of the resin, with good adhesion to the matrix, so as to dissipate cracking energy.

The impact modifier advantageously consists of a polymer with a flexural modulus below 100 MPa, measured according to the standard ISO 178, and a Tg below 0° C. (measured according to the standard 11357-2 at the point of inflection of the DSC thermogram), in particular a polyolefin.

The polyolefin of the impact modifier may be functionalized or non-functionalized or be a mixture of at least one which is functionalized and/or of at least one which is non-functionalized. To simplify, the polyolefin has been denoted (B) and functionalized polyolefins (B1) and non-functionalized polyolefins (B2) have been described below.

A non-functionalized polyolefin (B2) is conventionally a homopolymer or copolymer of alpha-olefins or diolefins, for instance ethylene, propylene, 1-butene, 1-octene or butadiene. Examples that may be mentioned include:
polyethylene homopolymers and copolymers, in particular LDPE, HDPE, LLDPE (linear low 15 density polyethylene), VLDPE (very low density polyethylene) and metallocene polyethylene;
propylene homopolymers or copolymers;
ethylene/alpha-olefin such as ethylene/propylene, EPR (abbreviation for ethylene-propylene-rubber) and ethylene/propylene/diene (EPDM) copolymers;
styrene/ethylene-butene/styrene (SEBS), styrene/butadiene/styrene (SBS), styrene/isoprene/styrene (SIS) and styrene/ethylene-propylene/styrene (SEPS) block copolymers;
copolymers of ethylene with at least one product chosen from salts or esters of unsaturated carboxylic acids, such as alkyl (meth)acrylate (for example methyl acrylate), or vinyl esters of saturated carboxylic acids, such as vinyl acetate (EVA), it being possible for the proportion of comonomer to be up to 40% by weight.

The functionalized polyolefin (B1) may be a polymer of α-olefins bearing reactive units (the functionalities); such reactive units are acid, anhydride or epoxy functions. By way of example, mention may be made of the preceding polyolefins (B2) grafted or copolymerized or terpolymerized with unsaturated epoxides, such as glycidyl (meth)acrylate, or with carboxylic acids or the corresponding salts or esters, such as (meth)acrylic acid (it being possible for the latter to be completely or partially neutralized with metals such as Zn, and the like), or else with carboxylic acid anhydrides, such as maleic anhydride. A functionalized polyolefin is, for example, a PE/EPR mixture, the weight ratio of which can vary within broad limits, for example from 40/60 to 90/10, said mixture being cografted with an anhydride, notably maleic anhydride, in a degree of grafting of, for example, from 0.01% to 5% by weight, advantageously from 2.8% to 5% by weight.

The functionalized polyolefin (B1) may be chosen from the following (co)polymers, grafted with maleic anhydride or glycidyl methacrylate, in which the degree of grafting is, for example, from 0.01% to 5% by weight:
PE, PP, copolymers of ethylene with propylene, butene, hexene or octene containing, for example, from 35% to 80% by weight of ethylene;
ethylene/alpha-olefin such as ethylene/propylene, EPR (abbreviation for ethylene-propylene-rubber) and ethylene/propylene/diene (EPDM) copolymers;
styrene/ethylene-butene/styrene (SEBS), styrene/butadiene/styrene (SBS), styrene/isoprene/styrene (SIS) and styrene/ethylene-propylene/styrene (SEPS) block copolymers;
copolymers of ethylene and vinyl acetate (EVA), containing up to 40% by weight of vinyl acetate;
copolymers of ethylene and alkyl (meth)acrylate, containing up to 40% by weight of alkyl (meth)acrylate; 15
copolymers of ethylene and vinyl acetate (EVA) and alkyl (meth)acrylate, containing up to 40% by weight of comonomers.

The functionalized polyolefin (B1) may also be chosen from ethylene/propylene copolymers, predominant in propylene, grafted with maleic anhydride and then condensed with monoamino polyamide (or polyamide oligomer) (products described in EP-A-20 0342066).

The functionalized polyolefin (B1) may also be a copolymer or terpolymer of at least the following units: (1) ethylene, (2) alkyl (meth)acrylate or saturated carboxylic acid vinyl ester and (3) anhydride such as maleic anhydride, or (meth)acrylic acid, or epoxy, such as glycidyl (meth)acrylate.

As examples of functionalized polyolefins of the latter type, mention may be made of the following copolymers, where ethylene preferably represents at least 60% by weight and where the termonomer (the function) represents, for example, from 0.1% to 13% by weight of the copolymer:
ethylene/alkyl (meth)acrylate/(meth)acrylic acid or maleic anhydride or glycidyl methacrylate copolymers;
ethylene/vinyl acetate/maleic anhydride or glycidyl methacrylate copolymers;
ethylene/vinyl acetate or alkyl (meth)acrylate/(meth)acrylic acid or maleic anhydride or glycidyl methacrylate copolymers.

In the preceding copolymers, the (meth)acrylic acid can be salified with Zn or Li.

The term “alkyl (meth)acrylate” in (B1) or (B2) denotes C1-C8 alkyl methacrylates and acrylates and may be chosen from methyl acrylate, ethyl acrylate, n-butyl acrylate, isobutyl acrylate, 2-ethylhexyl acrylate, cyclohexyl acrylate, methyl methacrylate and ethyl methacrylate.

Moreover, the abovementioned polyolefins (B1) may also be crosslinked via any suitable process or agent (diepoxy, diacid, peroxide, etc.); the term “functionalized polyolefin” also includes mixtures of the abovementioned polyolefins with a difunctional reagent such as diacid, dianhydride, diepoxy, etc. that is capable of reacting with these polyolefins or mixtures of at least two functionalized polyolefins which can react together.

The abovementioned copolymers, (B1) and (B2), can be copolymerized in random or block fashion and may have a linear or branched structure.

The molecular weight, the MFI index and the density of these polyolefins may also vary within a broad range, which will be perceived by a person skilled in the art. MFI is the abbreviation for the Melt Flow Index. It is measured according to the standard ASTM 1238 or ISO 1133:2011.

The non-functionalized polyolefins (B2) are advantageously chosen from polypropylene homopolymers or copolymers, and any ethylene homopolymer, or copolymer of ethylene and of a comonomer of higher alpha-olefin type, such as butene, hexene, octene, or 4-methyl-1-pentene. Mention may be made, for example, of PPs, high density PEs, medium density PEs, linear low density PEs, low density PEs or very low density PEs. These polyethylenes are known to those skilled in the art to be produced according to a “free radical” process, according to a “Ziegler” type catalysis or, more recently, according to a “metallocene” catalysis.

The functionalized polyolefins (B1) are advantageously chosen from any polymer comprising α-olefin units and units bearing polar reactive functions, such as epoxy, carboxylic acid or carboxylic acid anhydride functions. Examples of such polymers that may be mentioned include terpolymers of ethylene, of alkyl acrylate and of maleic anhydride or of glycidyl methacrylate, such as the Lotader® products from SK Global Chemical, or polyolefins grafted with maleic anhydride, such as the Orevac® products from SK Global Chemical, and also terpolymers of ethylene, of alkyl acrylate and of (meth)acrylic acid. Mention may also be made of polypropylene homopolymers or copolymers grafted with a carboxylic acid anhydride and then condensed with polyamides or monoamino oligomers of polyamide.

Advantageously, the impact modifier is a functionalized polyolefin (B1) bearing maleic anhydride or epoxide functions.

### [TPU]

According to certain embodiments, the compatibilizers may be chosen from thermoplastic polyurethanes. The TPUs that are useful as compatibilizers are as defined previously regarding the TPE copolymer of the composition according to the invention.

TPUs are commercially available, for example, from Covestro (Desmopan range) and BASF (Elastollan range).

### [Silanes]

According to certain embodiments, the compatibilizers may be chosen from molecules or macromolecules containing silane or alkoxysilane groups. Advantageously, the molecules used include one or more silane functions and also a function chosen from amines, hydroxyls, epoxides, carboxylic acids or maleic anhydrides. For example, the following molecules may be used: (3-aminopropyl)triethoxysilane, triethoxysilane, 2-(3,4-epoxycyclohexyl)ethyltrimethoxysilane, 3-aminopropyldimethylethoxysilane, 3-(2-aminoethylamino)propyldimethoxymethylsilane. This type of product is sold by suppliers such as Gelest, Shin-Etsu, Dow Corning or Merck.

### [Polysiloxanes]

According to certain embodiments, the compatibilizers may be chosen from polysiloxanes having the following structure:

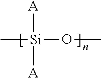

A possibly being chosen from methyl, ethyl, propyl, isopropyl or pentyl groups; advantageously, A is a methyl group.

Polysiloxanes are silicone oils of high molar mass (between 40 kg/mol and 40 kg/mol) which are commercially available in the form of masterbatches in various matrices.

Examples of commercial polysiloxanes are the MB 50 products from Dow Corning.

The compatibilizers are very advantageously chosen from copolyamides, notably comprising fatty acid dimer, impact modifiers, notably functionalized maleic anhydride or epoxide, TPUs, and mixtures thereof.

### [Compositions]

According to certain embodiments, when the composition comprises a PEBA copolymer and a TPU copolymer, the weight content, relative to the total weight of the composition, of the PEBA is greater than that of the TPU.

Preferably, the compositions according to the invention do not comprise any:
crosslinked polyurethane (PU) particles; and/or
thermoplastic SBS or SEBS, and/or
EPDM (ethylene-propylene-diene monomer) terpolymer

The composition according to the invention is thermoplastic, i.e. meltable.

The melting point of this composition may be between 100° C. and 220° C., notably between 120° C. and 190° C., preferably between 125° C. and 170° C.

Advantageously, the composition has a tan δ at 23° C. of less than or equal to 0.2, preferably less than or equal to 0.15, notably less than 0.10. The tan δ (or loss factor) at 23° C. corresponds to the ratio of the loss modulus E″ to the modulus of elasticity E′ measured at a temperature of 23° C. by dynamic mechanical analysis (DMA). It may be measured according to the 2019 standard ISO 6721, the measurement being performed at a tensile strain of 0.1%, at a frequency of 1 Hz, and at a heating rate of 2° C./min. The tan δ allows the elasticity of the composition to be characterized: the lower the tan δ, the greater the elastic recovery. The tan δ at 23° C. of the composition may be from 0.05 to 0.06, or from 0.06 to 0.07, or from 0.07 to 0.08, or from 0.08 to 0.09, or from 0.09 to 0.10, or from 0.10 to 0.11, or from 0.10 to 0.15, or from 0.15 to 0.2.

The dynamic coefficient of friction on a wetted aluminum substrate measured at a speed of 50 mm/min and up to an elongation of 25 mm according to the procedure SATRA TM 144: 2011 is generally greater than 0.35, preferably greater than 0.45.

According to a second aspect, the invention relates to a process for preparing a composition as defined above, comprising the following steps:
mixing, preferably in an extruder, advantageously in a co-kneader, of
   from 20% to 90% by weight, preferably from 40% to 70% by weight, of at least one TPE, preferably a copolymer, in the molten state and
   from 10% to 80%, preferably from 30% to 60%, by weight of at least one crosslinked rubber powder with a specific surface area of between 0.08 m²/g and 100 m²/g,
   from 0 to 5%, preferably from 0.1% to 4% and notably from 1% to 2% of additives,
   from 0 to 40%, preferably from 5% to 20% and notably from 10% to 15% of,
optionally, forming the mixture into the form of granules, filaments or powder, and/or
recovering the composition obtained.

The mixing step of the process may notably be performed by applying high shear, heating or irradiation to allow good dispersion of the rubber powder particles within the thermoplastic elastomer matrix and thus the production of a homogeneous mixture.

According to yet another aspect, the invention relates to an article consisting of, or comprising, at least one element consisting of, or comprising, a composition as described previously, said article preferably being chosen from footwear components such as soles, the footwear possibly being chosen from dress shoes, indoor sports shoes (volleyball, badminton, etc.), outdoor sports shoes (trail running, hiking, soccer, skiing, etc.), water booties (surfing, kayaking, etc.), parts of ski poles, racket handles (tennis, badminton, etc.) and golf club handles, goalkeeper's gloves (soccer, baseball, etc.), treadmills, aquatic equipment such as diving booties, mask and snorkel parts, spectacle frame parts (sleeves, temples, pads), ski mask frames, parts allowing vibration isolation in electronics and on machines, external battery cases, automotive parts (seals, end caps), toys, watch straps, buttons on machines (remote control buttons, etc.), seals, conveyor belt components.

Articles or elements consisting of a composition as described above may be manufactured notably by injection molding.

According to yet another aspect, the invention relates to a process for recycling an article according to the invention, comprising the following successive steps:
a) a) recovering, after optional separation, at least part of said article made of thermoplastic material comprising a composition according to the invention,
b) b) grinding the thermoplastic material to obtain particles,
c) c) melting the particles to obtain a molten mixture, and
d) d) optionally, adding other components to the molten mixture, and
e) e) optionally, forming granules, filaments or powders from the molten mixture obtained on conclusion of step c) or d), and
f) f) optionally, forming the granules, filaments or powders into shape.

Very advantageously, certain articles, such as sports shoes comprising a sole consisting of a composition in accordance with the invention, do not require a step of separation of the various elements in step a): they can be directly ground and melted to form a new article made of recycled thermoplastic material, for example a new sole for a sports shoe. This constitutes a considerable economic and ecological advantage over the composite materials currently used, notably in sports shoes, which are difficult to recycle.

According to yet another aspect, the invention relates to granules, filaments or powders that may be obtained according to the claimed recycling process.

According to yet another aspect, the invention relates to an article consisting of or comprising at least one element prepared from granules, filaments or powders that may be obtained via the claimed recycling process.

This article may be, for example, a sole for a shoe, notably a sports shoe.

### Definitions

Throughout the description, the terms listed below have the following meanings.

Throughout the description, the term “polyamide” (PA) denotes a homopolyamide or a copolyamide, i.e. the products of condensation of polyamide monomers, notably lactams, α,ω-aminocarboxylic acids and/or dicarboxylic acids and diamines.

In the present description of the polyamides, the term “monomer” should be taken as meaning “repeating unit”. The case where a repeating unit of the polyamide consists of the combination of a dicarboxylic acid with a diamine is particular. It is considered that it is the combination of a diamine and of a dicarboxylic acid, that is to say the diamine·diacid pair (in an equimolar amount), which corresponds to the monomer. This is explained by the fact that, individually, the dicarboxylic acid or the diamine is only a structural unit, which is not enough on its own to be polymerized. In the case where the polyamides according to the invention comprise at least two different monomers, known as “co-monomers”, i.e. at least one monomer and at least one co-monomer (monomer different from the first monomer), they comprise a copolymer such as a copolyamide, COPA for short. Copolyamides thus result from the polycondensation of several monomers forming polyamide units.

The nomenclature used to define polyamides is described in the standard ISO 1874-1:1992 “Plastics—Polyamide (PA) molding and extrusion materials—Part 1: Designation”, notably on page 3 (tables 1 and 2), and is well known to those skilled in the art. In PAL notation, PA denotes polyamide and L denotes the number of carbon atoms in the α,ω-aminocarboxylic acid or in the lactam. Thus, the polyamide is obtained by the polycondensation of α,ω-aminocarboxylic acid or lactam including L carbon atoms. In PAMN notation, M denotes the number of carbon atoms in the diamine and N denotes the number of carbon atoms in the dicarboxylic acid.

As α,ω-aminocarboxylic acids, mention may be made of C6 to C18 α,ω-aminocarboxylic acids, and in particular aminocaproic, 7-aminoheptanoic, 11-aminoundecanoic and 12-aminododecanoic acid.

As examples of lactams, mention may be made of C6 to C18 lactams and notably caprolactam, oenantholactam and lauryllactam.

As examples of dicarboxylic acids, mention may be made of linear or branched aliphatic, cycloaliphatic or aromatic C6 to C18 dicarboxylic acids, and notably 1,4-cyclohexanedicarboxylic acid, butanedioic acid, adipic acid, azelaic acid, suberic acid, sebacic acid, dodecanedicarboxylic acid, octadecanedicarboxylic acid, terephthalic acid and isophthalic acid, but also dimerized fatty acids.

As examples of diamines, mention may be made of linear or branched aliphatic, cyclic, saturated or unsaturated, C2 to C18 diamines, and notably tetramethylenediamine, hexamethylenediamine, 1,10-decamethylenediamine, dodecamethylenediamine, trimethylhexamethylenediamine, the isomers of bis(4-aminocyclohexyl)methane (BACM), bis(3-methyl-4-aminocyclohexyl)methane (BMACM) and 2,2-bis(3-methyl-4-aminocyclohexyl)propane (BMACP), and para-aminodicyclohexylmethane (PACM), and isophoronediamine (IPDA), 2,6-bis(aminomethyl)norbornane (BAMN) and piperazine (Pip).

The term “copolymer” means a polymer derived from the copolymerization of at least two chemically different types of monomer, referred to as comonomers. A copolymer is thus formed from at least two different repeating units. It may also be formed from three or more repeating units. More specifically, the term “block copolymer” means copolymers in the abovementioned sense, in which at least two different monomer blocks are covalently bonded. The length of the blocks may be variable. Preferably, the blocks are composed of from 1 to 1000, preferably 1 to 100 and in particular 1 to 50 repeating units. The link between the two monomer blocks may occasionally require an intermediate non-repeating unit known as a junction block.

The term “melting point” means the temperature at which a partially crystalline polymer passes to the viscous liquid state, as measured on the first heating (Tf1) by differential scanning calorimetry (DSC) according to the standard NF EN ISO 11 357-3 using a heating rate of 20° C./min.

It is moreover pointed out that, unless otherwise indicated, the physical quantities are measured under standard temperature and pressure conditions, notably at 23° C. and at atmospheric pressure.

The term “thermoplastic polymer” means a polymer which has the property of softening when heated sufficiently, and of becoming hard again on cooling.

The physical quantities, notably allowing the mechanical properties of the compositions according to the invention to be characterized, are as defined below:
the tensile modulus is measured according to the standard ISO 527-1A;
the stress at 50% strain is measured according to the standard ISO 527-1A;
the elongation at break is measured according to the standard ISO 527-1A;
the breaking stress is measured according to the standard ISO 527-1A;
the abrasion resistance is measured according to DIN 53516;
the dynamic coefficient of friction on a substrate is measured at a speed of 50 mm/min and up to an elongation of 25 mm according to the procedure SATRA TM 144: 2011
the Shore A or D hardness is measured after 3 sec according to the standard ISO 7619-1;
the recyclability is evaluated by the meltability or non-meltability of the composition.

It is moreover specified that the expressions “between . . . and . . . ” and “from . . . to . . . ” used in the present description should be understood as including each of the limits mentioned.

Unless otherwise mentioned, the percentages are expressed on a weight basis relative to the total weight of the composition.

### Examples

The following examples illustrate the invention without limiting it.

The following polymers were used:
PEBA No. 1: PEBA copolymer comprising PA 11 blocks with a number-average molar mass of 600 g/mol and flexible PTMG blocks with a number-average molar mass of 1000 g/mol, and a Shore D hardness of 25.
PEBA No. 2: PEBA copolymer comprising rigid PA 12 blocks with a number-average molar mass of 600 g/mol and PTMG blocks with a number-average molar mass of 2000 g/mol, and a Shore D hardness of 33.
Elastollan® 1185A: thermoplastic polyurethane commercially available from BASF.
Kraton® FG1901: triblock copolymer of styrene and ethylene/butylene with a polystyrene content of 30% and a branched maleic anhydride content of between 1.4% and 2%, commercially available from Kraton.
Lotader® AX8900 is a random copolymer of ethylene, acrylic ester and glycidyl methacrylate, commercially available from SK Chemicals.
TyreXol® CW 50 is a rubber powder derived from used tires, commercially available from TRS, with a specific surface area of 0.12 m²/g. The D50 diameter of this powder is 130 μm and the D90 is 270 μm.

Various compositions were prepared. The amounts, in mass percentages, of their constituents are indicated in Table 1 below.

TABLE 1

| | EC1 | EC2 | EI1 | EI2 | EI3 | EI4 | EI5 | EI6 | EI7 | EI8 |
|---|---|---|---|---|---|---|---|---|---|---|
| Crosslinked | 100 | | | | | | | | | |
| synthetic | | | | | | | | | | |
| rubber sheet | | | | | | | | | | |
| PEBA 1 | | 100 | | | | 62 | | 50 | | |
| PEBA 2 | | | 82 | 62 | 72 | | 50 | | | |
| Elastollan ® | | | | | | | | | 50 | |
| 1185A | | | | | | | | | | |
| Kraton ® | | | | | | | | | | 50 |
| FG1901 | | | | | | | | | | |
| Lotader | | | 8 | 8 | 8 | 8 | | | | |
| AX8900 | | | | | | | | | | |
| TyreXol CW50 | | | 10 | 30 | 20 | 30 | 50 | 50 | 50 | 50 |
| tire powder | | | | | | | | | | |

The above compositions EC2 to E14 were manufactured using a ZSK 18 mm twin-screw extruder (Coperion). The barrel temperature was set at 180° C. and the screw speed was 280 rpm with a flow rate of 8 kg/h.

Compositions E15 to E18 were produced using a PR46 co-kneader (Buss). The barrel and intake screw temperatures were set at 175° C. The speed of the co-kneader was set at 250 rpm and the intake screw at 20 rpm, with a flow rate of 15 kg/h.

Composition EC1 is a crosslinked synthetic rubber sheet.

The compositions were subsequently dried under reduced pressure at 80° C. in order to achieve a moisture content of less than 0.04%.

1A test specimens (according to the standard ISO 527), 6 mm sheets and 2 mm sheets were manufactured by injection molding using a Battenfeld BA800 CDC press and unpolished molds. The following parameters were applied during the injection:
Barrel temperature: 150° C.
Nozzle temperature: 170° C.
Mold temperature: 20° C.
Cycle time: 60 seconds.

Various properties of these compositions were evaluated:
the dynamic coefficient of friction on a wetted aluminum plate measured at a speed of 50 mm/min and up to an elongation of 25 mm according to the procedure SATRA TM 144: 2011
the recyclability is evaluated by the meltability or non-meltability of the composition. When the composition is meltable, i.e. transforms under the effect of heat into a fluid melt, it is classified as (+), whereas when the composition is not meltable, it is classified as (−).

All these evaluations were performed on dry (unconditioned) test specimens.

The results are presented in Table 2 below.

TABLE 2

| | EC1 | EC2 | EI1 | EI2 | EI3 | EI4 | EI5 | EI6 | EI7 | EI8 |
|---|---|---|---|---|---|---|---|---|---|---|
| Dynamic coefficient | 0.55 | 0.32 | 0.51 | 0.61 | 0.61 | 0.54 | 0.71 | 0.62 | 0.83 | 0.85 |
| of friction on | | | | | | | | | | |
| wetted Al (speed 50 | | | | | | | | | | |
| mm/min) | | | | | | | | | | |
| Recyclability | − | + | + | + | + | + | + | + | + | + |
| (meltable) | | | | | | | | | | |

The compositions according to the invention are found to be recyclable (meltable) and to have a high dynamic coefficient of friction on a wet aluminum substrate, giving them good antislip properties.

1. A composition comprising, relative to the total weight of the composition:
from 20% to 90% by weight of at least one thermoplastic elastomer (TPE),
from 10% to 80% by weight of at least one crosslinked rubber powder, the crosslinked rubber powder having a specific surface area of between 0.08 m2/g and 100 m2/g,
from 0 to 5% by weight of additives;
from 0 to 40% by weight of compatibilizers.

2. The composition as claimed in claim 1, in which the crosslinked rubber powder has a specific surface area of between 0.08 m2/g and 0.5 m2/g.

3. The composition as claimed in claim 1, in which the crosslinked rubber powder has a median diameter D50 of between 2 and 500 μm.

4. The composition as claimed in claim 1, in which the D90 diameter is between 10 and 800 μm.

5. The composition as claimed in claim 1, in which the rubber of the crosslinked rubber powder is a natural or synthetic rubber or a mixture thereof.

6. The composition as claimed in claim 1, in which the rubber of the crosslinked rubber powder contains from 10% to 80% by weight of natural rubber.

7. The composition as claimed in claim 4, in which the natural rubber is cis-1,4-polyisoprene or trans-1,4-polyisoprene.

8. The composition as claimed in claim 1, in which the crosslinked rubber powder comprises styrene-butadiene rubber.

9. The composition as claimed in claim 1, in which the crosslinked rubber powder is derived from used tires.

10. The composition as claimed in claim 1, in which the crosslinked rubber powder is obtained by water-jet chopping of a tire.

11. The composition as claimed in claim 1, in which the crosslinked rubber powder contains from 1% to 70% of carbon black and/or silica.

12. The composition as claimed in claim 1, in which the at least one TPE is chosen from polyamide elastomers, thermoplastic polyurethanes, polyester elastomers, styrene-butadiene block copolymers and styrene-ethylene-butadiene block copolymers, and mixtures thereof.

13. The composition as claimed in claim 1, in which the TPE comprises flexible polyether and/or polyester blocks, and/or rigid blocks chosen from polyamides, polyurethanes and polyesters.

14. The composition as claimed in claim 12, in which the rigid block is a polyamide comprising at least one Z- or XY-type unit:
Z being a lactam or amino acid containing from 6 to 18 carbon atoms,
X being a diamine containing from 4 to 48 carbon atoms,
Y being a diacid containing from 6 to 48 carbon atoms.

15. The composition as claimed in claim 12, in which the rigid block is a polyurethane comprising at least one XY unit:
X being a diisocyanate,
Y being a diol.

16. The composition as claimed in claim 12, in which the rigid block is a polyester comprising at least one XY unit:
X being a dicarboxylic acid,
Y being a diol.

17. The composition as claimed in claim 12, in which the ratio of flexible blocks to rigid blocks is chosen so that the tensile modulus according to ISO 527 is between 5 and 800 MPa.

18. The composition as claimed in claim 1, in which the TPE has a Shore hardness of between 10 D and 70 D.

19. A process for preparing a composition as claimed in claim 1, comprising the following steps:
mixing of
20% to 90% by weight of at least one thermoplastic elastomer TPE in the molten state and
from 10% to 80% by weight of at least one crosslinked rubber powder with a specific surface area of between 0.08 m2/g and 100 m2/g,
from 0 to 5% of additives;
from 0 to 40% of compatibilizers,
optionally, forming the mixture into the form of granules, filaments or powder, and/or
recovering the composition obtained.

20. An article comprising at least one element comprising a composition as claimed in claim 1.

21. A process for manufacturing an article, comprising the steps of:
a composition as claimed in claim 1;
injection molding of said composition.

22. A process for recycling an article, comprising the following successive steps:
a) recovering, after optional separation, at least part of said article made of thermoplastic material comprising a composition as claimed in claim 1,
b) grinding the thermoplastic material to obtain particles,
c) melting the particles to obtain a molten mixture, and
d) optionally, adding other components to the molten mixture,
e) optionally, forming granules, filaments or powders from the molten mixture obtained on conclusion of step c) or d), and
f) optionally, forming the granules, filaments or powders into shape.

23. A granule, filament or powder which may be obtained according to the recycling process as defined in claim 21.

24. An article comprising at least one element prepared from granules, filaments or powders as claimed in claim 22.
